(19) United States
(12) Patent Application Publication
(10) Pub. No.: US 2004/0014519 A1
(43) Pub. Date: Jan. 22, 2004

(54) Gaming apparatus and gaming apparatus control method

(76) Inventor: Hideaki Iwamoto, Tokyo (JP)

Correspondence Address: THE LAW OFFICE OF JOHN A. GRIECCI, 703 PIER AVE., SUITE B #657, HERMOSA BEACH, CA, 90254, US

(21) Appl. No.: 10/400,139

(22) Filed: Mar. 25, 2003

(30) Foreign Application Priority Data
Jul. 17, 2002 (JP) 2002-208862

(51) Int. Cl. A63F 13/00

(52) U.S. Cl. 463/20

(57) ABSTRACT

The Toby symbol T1 as a key symbol stops on a display region when predetermined conditions are fulfilled and the Toby character t1 from the Toby symbol T1 moves towards a display region that is varying when at least one of other display regions is varying. It is possible to offer a highly elaborated gaming apparatus.

### FIELD OF THE INVENTION

The present invention relates to a gaming apparatus which varyingly displays symbols on a plurality of display regions, a method of controlling the gaming apparatus, a program, and a computer-readable recording medium.

### RELATED ART

Slot machines can be cited as typical examples of gaming apparatuses on which the symbols to be displayed on each of a plurality of display regions are determined by random number values and a prize is judged based on the arrangement of the symbols on the display. With the recent “game boom”, slot machines are gaining great popularity in casinos and amusement arcades. In this kind of slot machines, as a scheme for increasing player interest, it has become a popular trend to offer a function that characters move over a plurality of display regions on a display.

However, in the slot machines described above, the aforementioned character moves to the display regions after all the display regions on a display have stopped. Players who want more excitement are not satisfied with gaming apparatuses which have this kind of conventional action, and want even newer gaming apparatuses to appear.

The present invention has been designed in order to solve the aforementioned problems, and it is an object thereof to provide a gaming apparatus whose amusement ability is enhanced, a method of controlling the gaming apparatus, a program, and a computer-readable recording medium.

### SUMMARY OF THE INVENTION

In order to realize the object described above, a gaming apparatus comprising: a display having a plurality of display regions on which a plurality of types of symbols is varyingly displayed; and a controller for executing a prescribed program and controlling a display content of the display;

wherein the controller, according to the program, determines the symbols to be displayed on each display region from among the plurality of symbols; stops sequentially the symbol on each of display regions that are varyingly displayed; stops a key symbol on a predetermined display region when predetermined conditions have been fulfilled; moves a predetermined character from the key symbol towards a display region that is varyingly displayed when at least one of the other display regions is varying.

When at least one display region described above is varying, a predetermined character from a key symbol moves into a plurality of display regions. So, it is possible to give a player a novel feeling to increase excitement of a gaming apparatus.

In the case that a plurality of the display regions forms a line and the varying displays stop in a sequential order, the character preferably repeatedly moves into an adjacent display region after the display region that is adjacent to the region in which the character exists has stopped when at least one of the other display regions is moving.

By doing so, the character moves to the adjacent display region after the varying display of the adjacent display region has stopped and, therefore, the player can feel as if the character makes the varying display of the adjacent display region stop. As the result, the player is strongly attracted to the aforementioned character and amusement ability of a gaming apparatus is enhanced.

At this moment, if predetermined conditions are fulfilled, it is preferable that a bonus symbol stops on a display region that stops last among a plurality of display regions, a mode to give a player a bonus starts and the character moves to a display region on which the bonus symbol is displayed.

It is possible to attract attention of a player to the character by moving the character toward a display region on which a bonus symbol is displayed. Further, by stopping a bonus symbol last it is possible to maintain player's expectation for a long time and enhance amusement ability of a gaming apparatus.

It is preferable that a plurality of reel images is displayed in a display as a plurality of the display regions and a key symbol can be displayed only in a reel image that stops varying display first from among a plurality of reel images.

It is possible to move the character onto the display region from the key symbol for a long time by displaying the key symbol in a reel that stops varying display first among a plurality of reels. For example, in the case a bonus symbol is displayed in a reel that stops varying display last, it is possible to maintain players' expectation of appearance of a bonus symbol for a long period of time to enhance amusement character of a gaming apparatus.

The control method of the gaming apparatus according to the present invention includes: a display having a plurality of display regions on which a plurality of types of symbols varies; the steps of: executing a predetermined program; and determining symbols to be displayed on each of display regions from among a plurality of types of symbols; sequentially stopping the symbols on which each display regions that are varied; stopping varying of a key symbol on a predetermined display region if predetermined conditions have been fulfilled; moving a predetermined character from the key symbol to a display region that are varyingly displayed when at least one display region is varying.

By moving a predetermined character from the key symbol onto a plurality of display regions toward the display regions varyingly displayed when at least one of the display region is varying allows a player to experience the novel feeling to enhance amusement ability of a gaming apparatus.

In the case that a plurality of the display regions is in a line and the varying display stops sequentially, it is preferable to repeat a step of moving a character to a display region that is adjacent to a region in which the character exists after the adjacent display region has stopped varying when at least one display region is varying.

As a result, because the character moves to the adjacent display region after the adjacent display region has stopped varying, a player can feel as if the character makes the adjacent display region stop varying display. As a result, player's expectation is strongly attracted to the game and amusement ability of a gaming apparatus is enhanced.

The program according to the present invention is characterized in that making a computer execute the steps of: displaying a plurality of display regions on which a plurality of type of symbols is varyingly displayed; determining symbols from among a plurality of types of symbols to be displayed on each display region; stopping sequentially symbols on each display regions that are varyingly displayed; making a key symbol stop on a predetermined display region when a predetermined conditions have been fulfilled; making a predetermined character move towards the varying display region from the key symbol when predetermined conditions have been fulfilled when at least one of other display regions is varying.

The computer-readable recording medium according to the present invention is characterized in that the aforementioned program is recorded therein.

It is possible to obtain the effect as described in the explanation of the gaming apparatus and the control method of the gaming apparatus by making a computer execute the program according to the present invention or a program recorded on the recording medium. In other words, when at least one of the display regions is varying, making a predetermined character from a key symbol move to a plurality of display regions allows a player to experience a novel feeling to enhance amusement ability of a gaming apparatus.

Other features and advantages of the invention will be apparent from the following description taken in connection with the accompanying drawings.

### BRIEF DESCRIPTION OF THE DRAWINGS

FIG. 1 is an entire perspective view of an embodiment of a gaming apparatus according to the present invention;

FIG. 2 is a block diagram of a controller to control a slot machine and various kinds of actuators connected thereto;

FIG. 3 is a view of a display of a display screen;

FIG. 4 is a symbol table showing the symbols displayed on each display region;

FIG. 5A is a view showing an example of the “pay line” of the slot machine;

FIG. 5B is a view showing another example of the “pay line” of the slot machine;

FIG. 6 shows a flow chart of illustrating a basic game of a slot machine in accordance with the present embodiment;

FIG. 7 shows a flow chart of an attraction stage of a slot machine according to the present embodiment;

FIG. 8 is a view of a display screen where each reel image is varying;

FIG. 9 is an illustration of a display screen where a Toby symbol which is a key symbol is displayed on the display region A2;

FIG. 10 is a view of a situation where the Toby character moves from the display region A2 to B2;

FIG. 11 is a view of a display screen where the Toby character moves to the display region D2;

FIG. 12 is a view of a display screen where the reel image E has been stopped and a Madonna symbol or Bull symbol is displayed on the display region E2;

FIG. 13 is a configuration diagram showing each module in the program of the present invention; and

FIG. 14 is a diagram showing a computer-readable recording medium (CD-ROM) in which the program of FIG. 13 is recorded.

### PREFERRED EMBODIMENT OF THE INVENTION

Below, the preferred embodiments of the invention are described in detail, referring to the accompanying drawings. Note that the same key numbers are used for identical elements and repetitive descriptions are omitted.

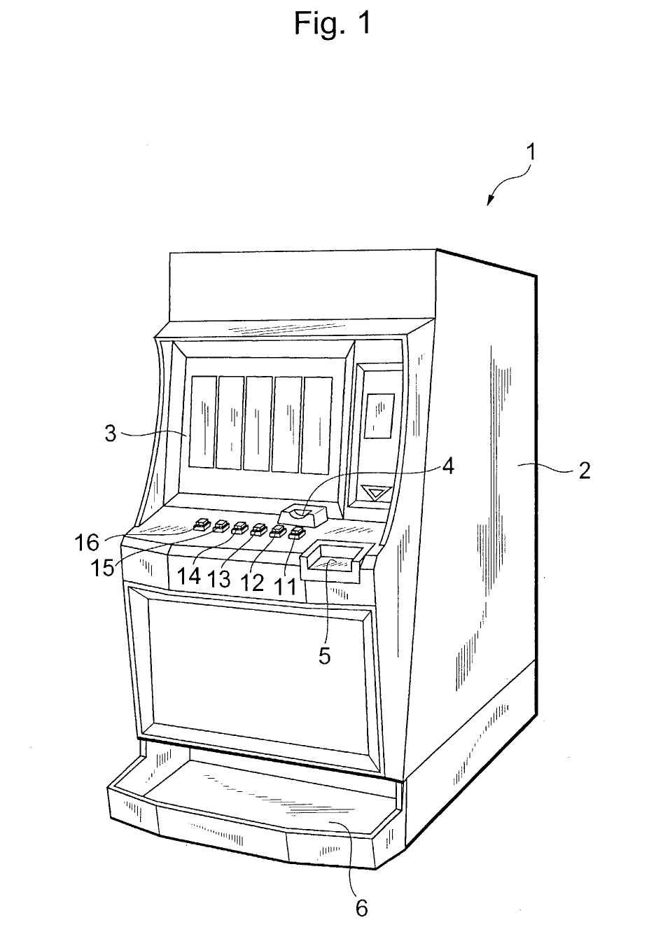

FIG. 1 is an entire perspective view showing a slot machine as gaming apparatus according to the present embodiment. The slot machine 1 has a case 2 which is equipped with a display 3 comprised of liquid crystal display for a digital display of a slot game. Below and in front of the display 3 are provided a coin slot 4 for inserting a medium such as a token or coin (below, these are referred to by the general term “coin”), and a bill inserter 5 for inserting bills. The player can play the slot game using either coins or bills. Of course, it is also possible to design the apparatus such that the game is conducted using only coins or bills. In addition, in the lowest part of case 2, a coin receiving part 6 is provided where the player receives the coins that are paid out.

Moreover, in front of the coin slot 4, six push buttons are arranged. These are buttons provided on commonly known slot machines, and in order from the right side includes: a start button 11 for directing the start of symbol rotation, a BET button 12 for indicating an 1 BET, a MAXBET button 13 for placing a BET from the number of remaining credits up to the maximum bet number (for example 20), a REPEATBET button 14 for placing a BET of the same amount as in the previous play, a collect button 15 for confirming the coins which have been won in the games, and a payout button 16 which instructs that the coins be paid out.

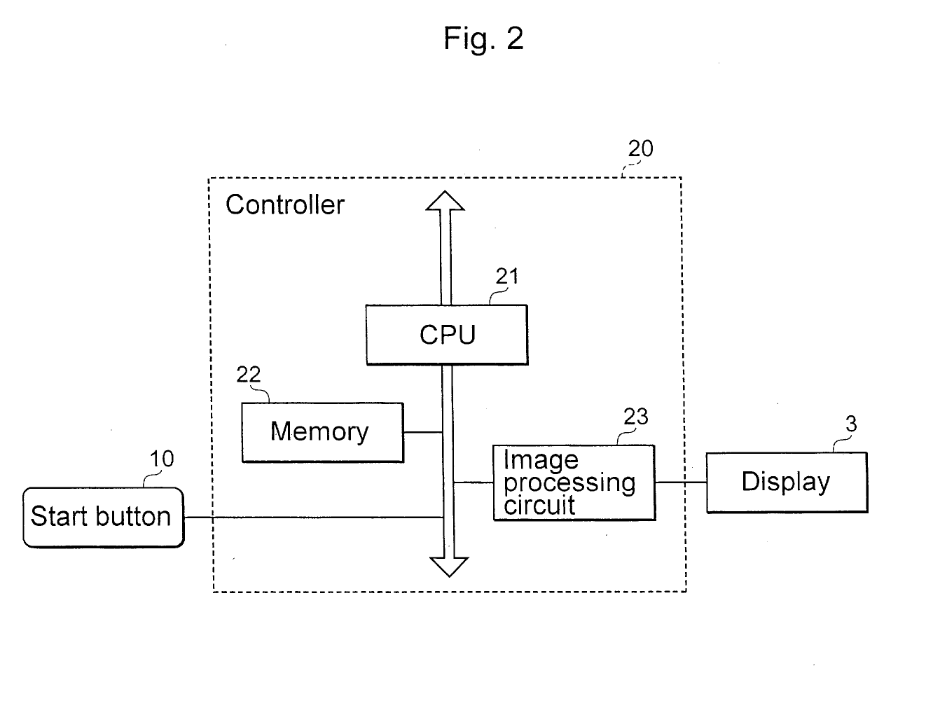

FIG. 2 is a block diagram showing the controller that controls the processing of slot machine of this embodiment and the various actuators which are electrically connected thereto.

Included in the controller 20 are: a CPU 21 for integrating the various control functions; a memory 22, serving as a storage means storing the program and data necessary for the slot game; an image processing circuit 23 which has Video RAM and controls the display content of the main display 3. In addition, between the CPU 21 and the various actuators, I/O ports and so on are appropriately placed.

Memory 22 has ROM area and RAM area, and in the ROM area thereof are included at least a program, which contains a module for executing the basic game and the attraction stage (described below); and data related to symbol images and to a pay table showing the dividend according to the symbol arrangement. Likewise, in the RAM area of memory 22, variable data such as the player's BET number, credit number, and so on are written in.

Further, connected to the CPU 21 via a bus are: a coin sensor for detecting the insertion of a coin, a start button 11. In addition, although omitted from the drawings, various buttons, a bill sensor, and so on are also connected to the controller 20.

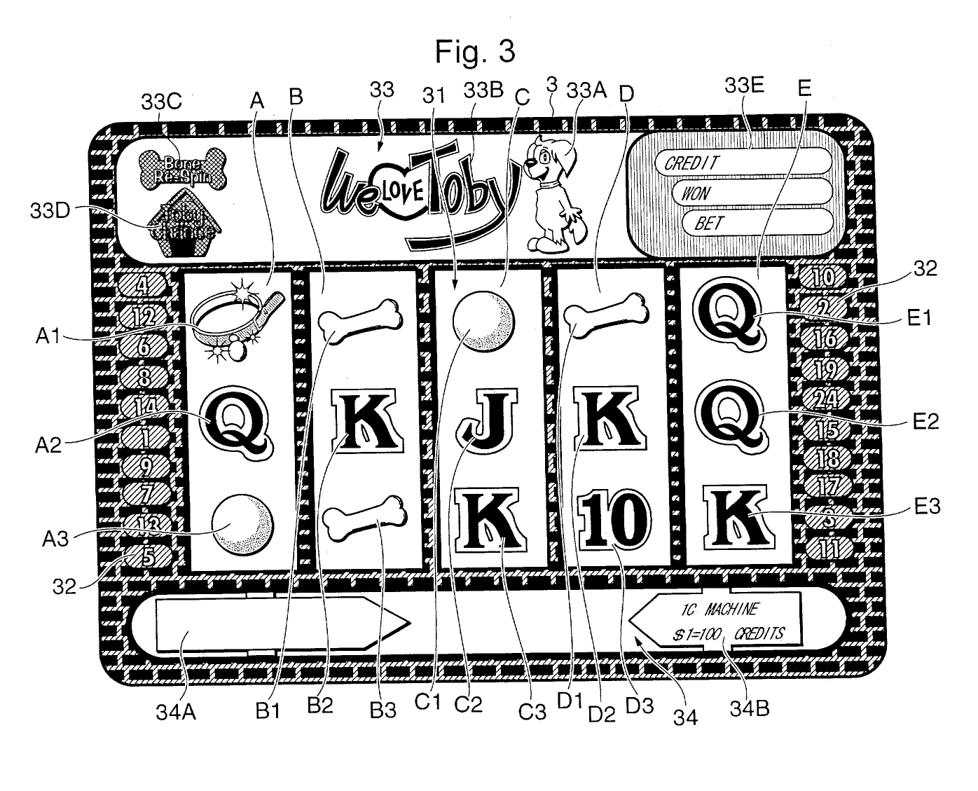

FIG. 3 is a view that shows an example of the display screen of display 3, wherein the present embodiment, the display region 31, line number display 32, upper display 33 and lower display 34 are displayed.

A total of fifteen display regions, 3 rows by 5 columns, are provided on the display region 31 for displaying a plurality of symbols. In addition, image processing is done such that reels with a plurality of types of symbols depicted on the circumferences thereof rotate, and when each reel stops, the selected symbols are displayed on display regions A1 through A3, B1 through B3, C1 through C3, D1 through D3, and E1 through E3.

Both sides of the display region 31, the line number display 32 on which line numbers indicating each pay line are displayed. Among the line numbers indicated on the line number display 32, line numbers which correspond to the pay line selected by the player are illuminated while the numbers not selected by the player are not illuminated.

On the upper side of the display region 31, the upper display 33 is formed. A dog image 33A nicknamed “Toby” that is a mascot in the slot machine of this embodiment is displayed at the central part of the upper display 33. At the side of the “Toby”, ornamental writing image 33B “WE LOVE TOBY” is displayed. In addition, at the upper left side of the upper display 33, a bone image 33C is displayed. And a doghouse image 33D is displayed under the bone image 33C. The bone image 33C and doghouse image 33D are illumined in the predetermined special game. Further, a credit number image is formed at the right side of the upper display 33. In the credit number image, the number of coin currently credited, number of coin that can be obtained in one game and number of BET coins in one game are displayed.

Under the display region 31, a lower display 34 is formed. At the left side of the lower display 34, a character information display region 34 A is formed to indicate a situation, for example, when a bonus game is played. Further, a charge indicator region 34B for indicating a charge for one BET.

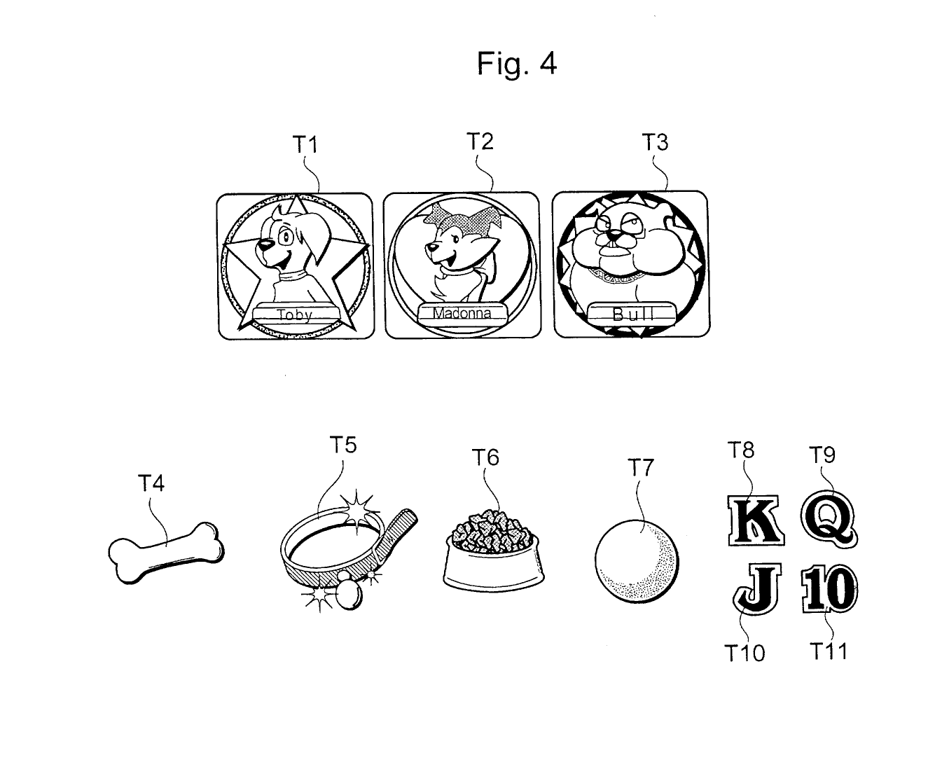

FIG. 4 is a symbol table showing the symbols displayed on each region. The symbols of the embodiment include Toby symbol T1, Madonna symbol T2 and Bull symbol T3, and so on.

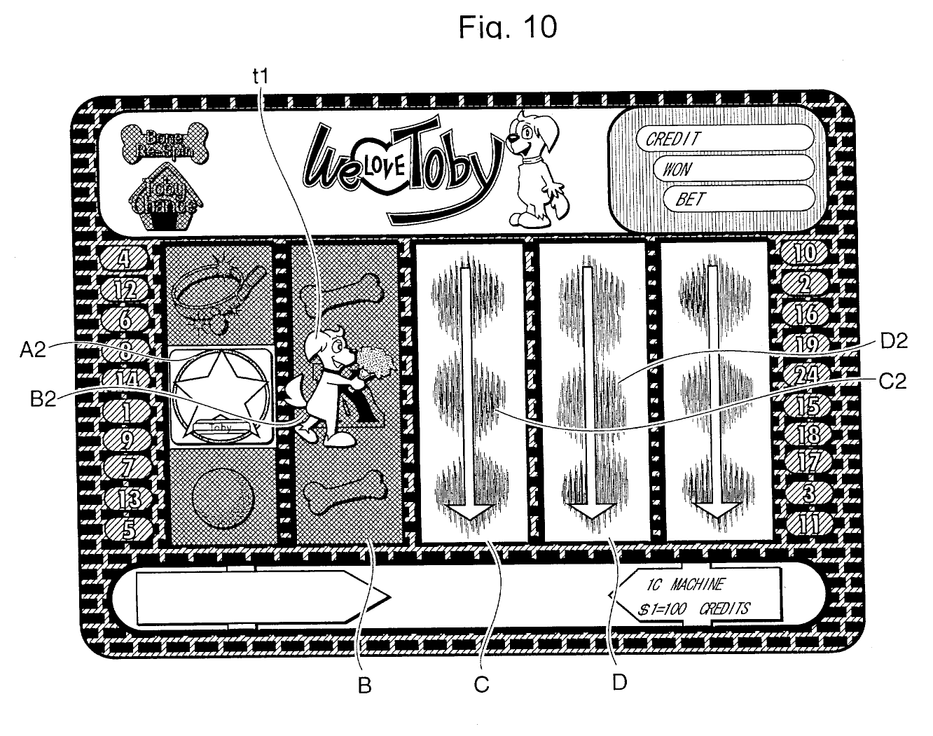

Toby symbol T1 is a symbol using a male dog nicknamed “Toby” as a motif. The Toby symbol T1 is set only in the reel image A and can be displayed on only any one of display region A1, A2 or A3 that is first displayed after stopping varying display. The Toby symbol T1 functions as a key symbol. If the Toby symbol T1 stops on a display region, the apparatus shifts to the attraction stage. Although details are described below, in the attraction stage, when at least one of the display regions is varyingly displayed, the apparatus executes an attraction where a Toby character t1 (referring to FIG. 10) moves from Toby symbol T1 towards a display region that is varyingly displayed. Then, a predetermined bonus game is played.

The Madonna symbol T2 and Bull symbol T3 are prepared for bonus symbols. Normal symbols include the bone symbol T4, collar symbol T5, food symbol T6, ball symbol T7 and card symbol. Card symbols include the king symbol T8, queen symbol T9, jack symbol T10 and number symbol T11.

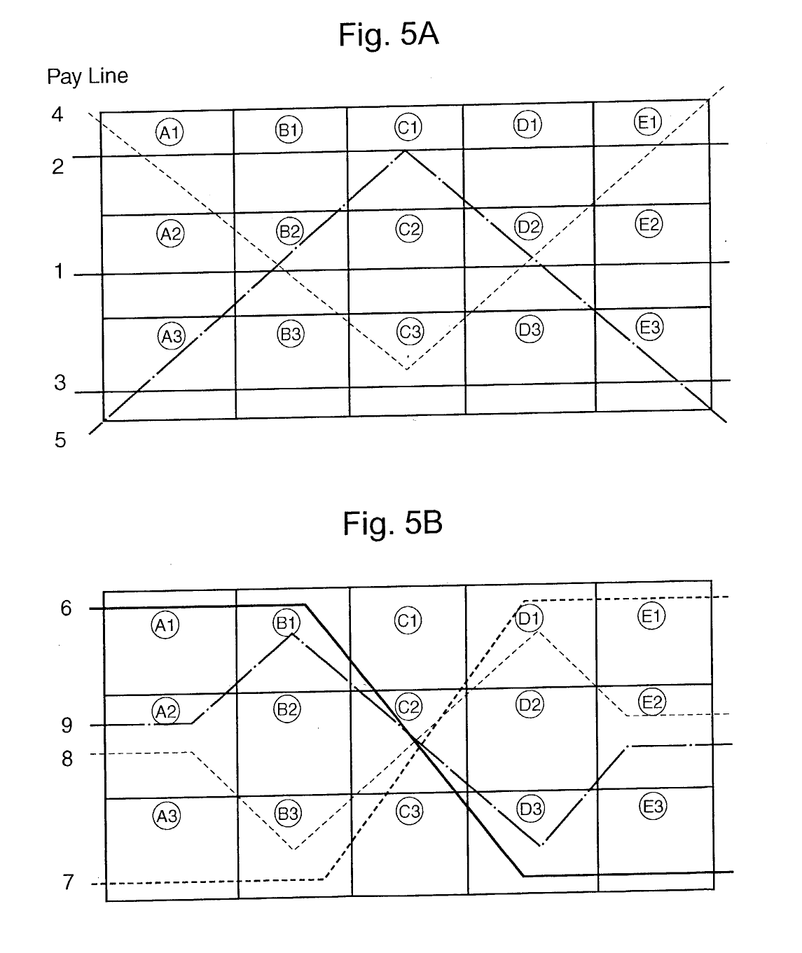

FIG. 5A and FIG. 5B are diagrams showing an example of the pay lines of the slot machine 1. To facilitate comprehension, pay lines are shown separated into two figures. As shown in each figure, nine pay lines have been prepared. If the prescribed symbols line up on any of these pay lines, a dividend is paid to the player according to the way the prescribed symbols line up. In addition, although omitted from the drawings, other eleven pay lines (twenty pay lines in total) are prepared. With the 3 rows by 5 columns layout of the present embodiment, because the number of columns has been increased in this way, a variety of pay lines can be configured. If a specified prize condition is fulfilled, one type of symbols among the aforementioned normal symbols are displayed on all display regions in one pay line to announce a specified payout is carried out.

Prize is determined by judging whether the same symbols line up on the pay line specified by the player from among twenty pay lines set in A1 through A3, B1 through B3, C1 through C3, D1 through D3, and E1 through E3. If the same symbols line up on the pay line specified by the player, it is judged to be fulfilling the prize condition, and a predetermined amount of coins is paid.

The basic game and attraction stage described above are controlled by cooperation of CPU 21, memory 22, image processing circuit 23 of the controller 20, and display 3.

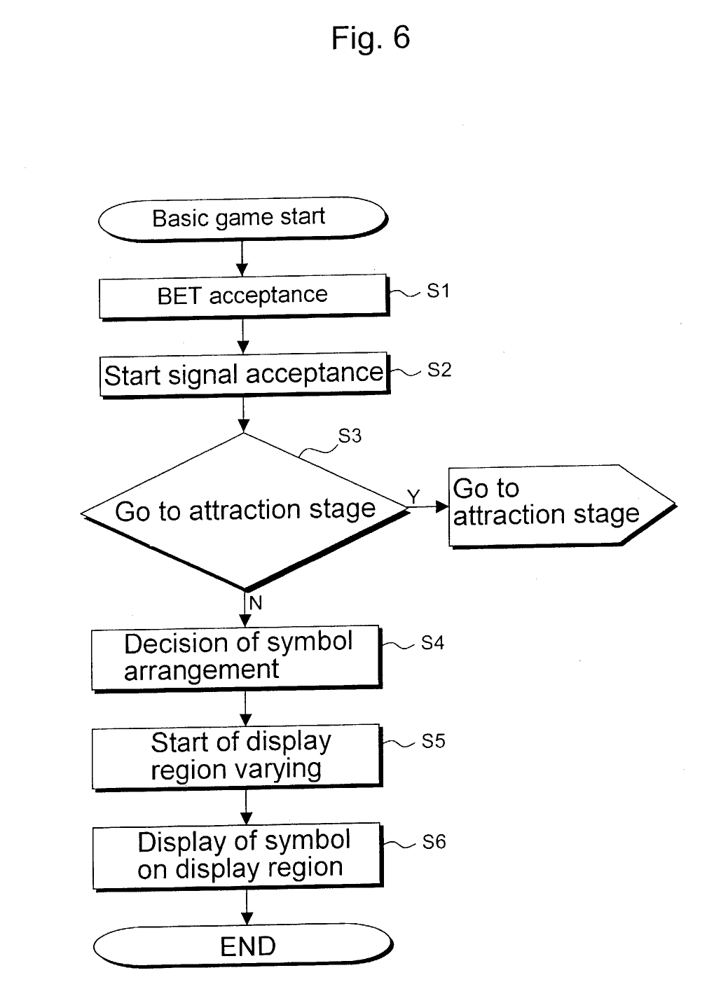

Next, the control method of the slot machine 1 of the present embodiment will be described. FIG. 6 is a flow chart of the basic game of the slot machine 1 according to the present invention. At first, the flow of the basic game will be explained now referring to FIG. 6.

When the slot machine 1 is operated, the CPU 21 accesses the memory 22 and transfers the information related to the basic screen of the slot machine 1, such as a framework to form the display region, to the image processing circuit 23. First, the image processing circuit 23 stores this information in Video RAM, and then makes the display 3 display. In this way, the slot machine 1 goes into the state where a player can play the slot game. The following processing is accomplished by the CPU 21 executing the module relating to the slot game of the program stored in the memory 22. When the slot machine 1 is operated, the slot machine has a state where a basic game is operated as a slot game.

In step S1, the CPU 21 of the controller 20 awaits the player's BET. A BET can be placed in a situation where credits remain, and the player indicates the BET number using any of the BET button 12, MAXBET button 13, or REPEATBET button 14.

After BET is complete, the player pushes the start button 11 (S2). Then, the CPU 21 determines if the conditions to run an attraction stage are fulfilled before the varying display to show rotation of the reel rotation (S3). If the player pushed MAXBET button 13, or REPEATBET button 14, the same determination is executed without the START button 11 being pressed. This decision is made by using random number values by means of the program saved on the memory 22.

For example, if random numbers are generated in a range from integer 0 to 400, and random number values 100, 200, 300 and 400 are obtained, the apparatus shifts to the attraction stage as the predetermined conditions have been fulfilled. This selection, based on random number values, can be done with any timing. For example, the selection may be done when the start button 11 is pushed, re-selection may be done each time the BET button is pushed, or the varying of reel image A to E starts.

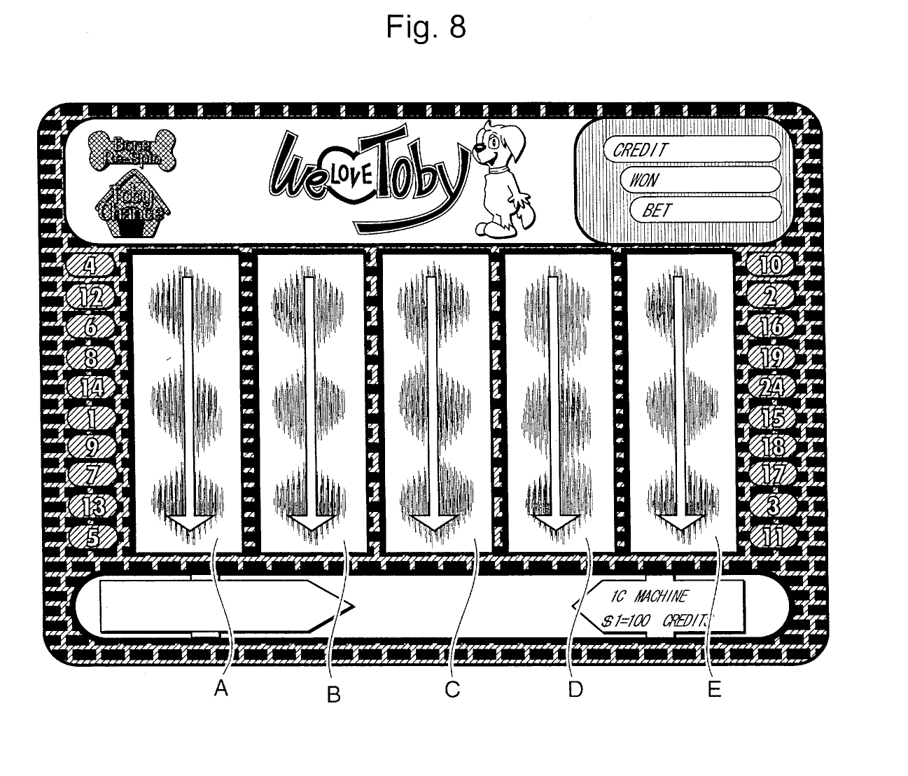

On the other hand, in the step S3, if it is determined not to run an attraction stage, the CPU 21 decides the arrangement of symbols to announce the result of the decision to the player (S4). As shown in FIG. 8, after the arrangement of symbols has been decided, all display regions are made to vary by varying each reel image A to E on the display 3 (S5). The CPU 21 performs image processing to make it appear as though actual reels are spinning by controlling the image processing circuit 23. The reel images A to E sequentially stop in the order (from A to E) to display a predetermined symbol on each display region as shown in FIG. 3 (S6). The player can know the result of the basic game by the display. If the same symbols line up on a pay line specified by the player, a predetermined amount of coin is paid out.

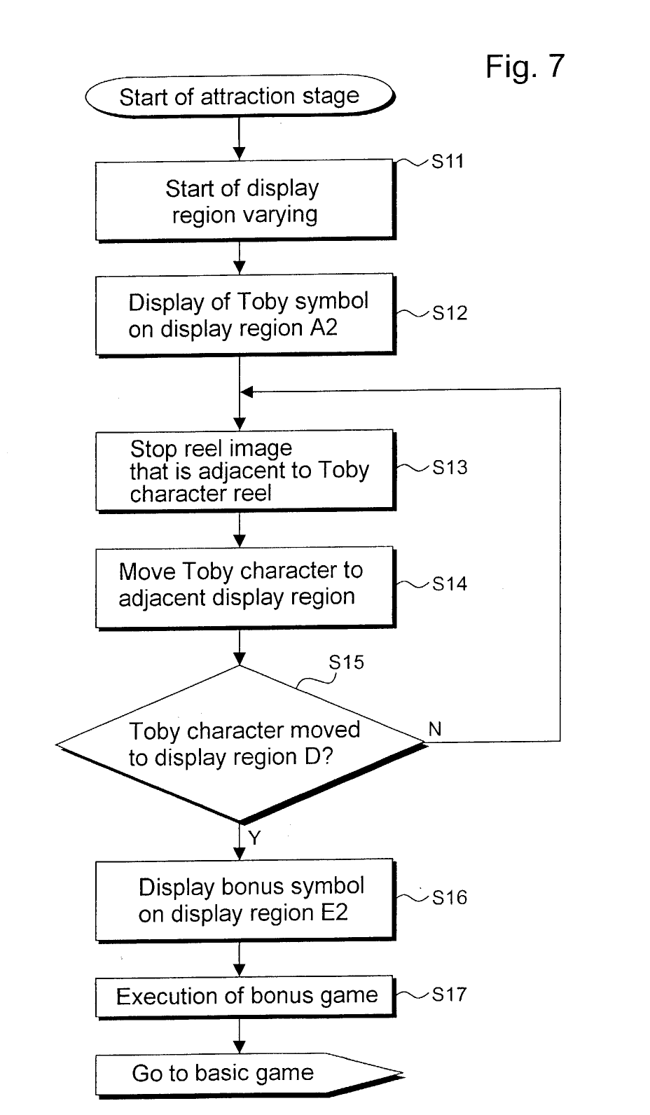

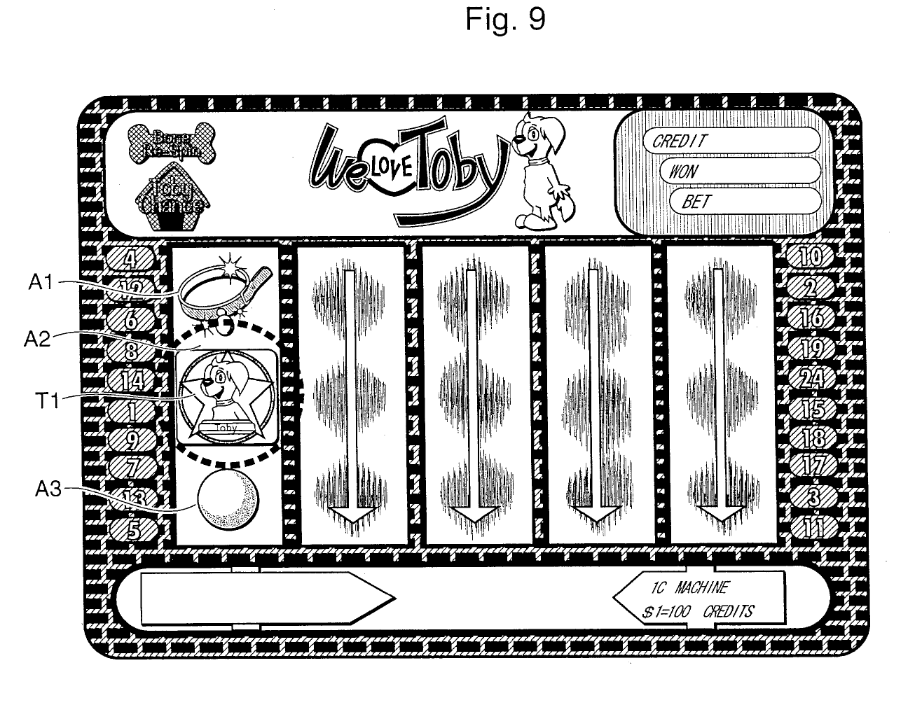

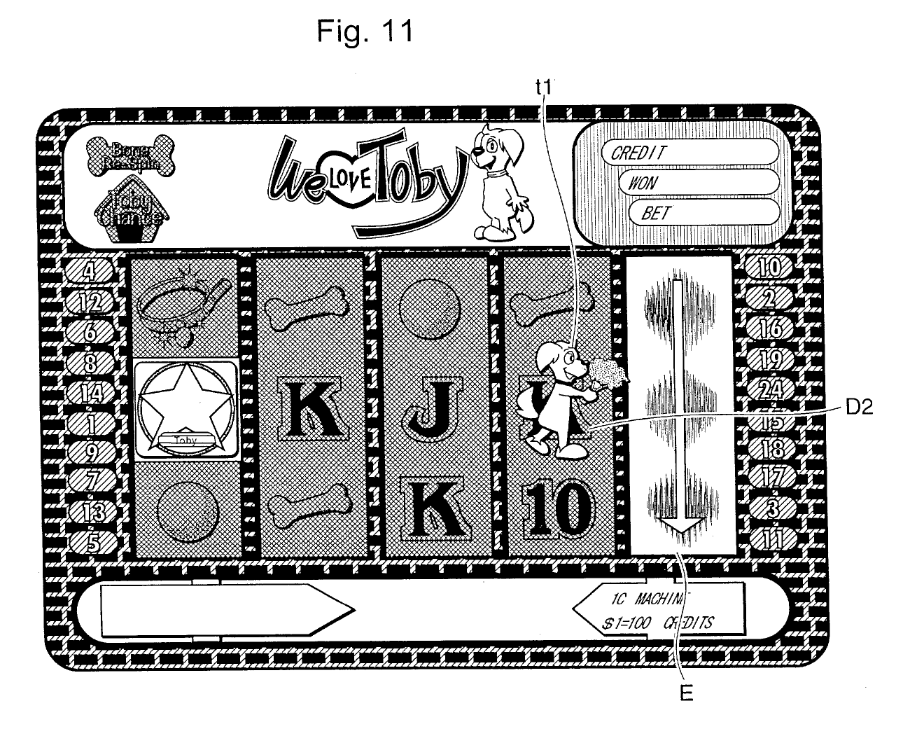

If the conditions to transfer to the attraction stage have been fulfilled in the step S3, a flow will take place as shown FIG. 7. After switching to the attraction stage based on the selection results of random number values in step S3 of the basic game, the attraction takes place on the display 3 as follows. As shown in FIG. 8, all display regions are made to be varyingly displayed by the rotation of each reel image A to E on the display 3 (S11). Then, as shown in FIG. 9, the Toby symbol T1 is made to stop on the display region A2 (S2). After that, as shown in FIG. 10, the reel image B including the display region that is adjacent to the display region where the Toby character t1 exists is made to stop (S13). The Toby character t1 is transferred from the display region A2 to B2 (S14). Here, step S13 and step S14 are repeated until the Toby character t1 moves to the display region D2 (S15). In other words, after the Toby character t1 moves from the display region A2 to B2, the reel image C is made to stop, the Toby character t1 is transferred from the display region B2 to C2, then, the reel image D is made to stop, and the Toby character t1 is made to transfer from the display region C2 to D2. By these procedures, as shown in FIG. 11, the Toby character t1 is displayed on the display region D2 when the reel image E is varying.

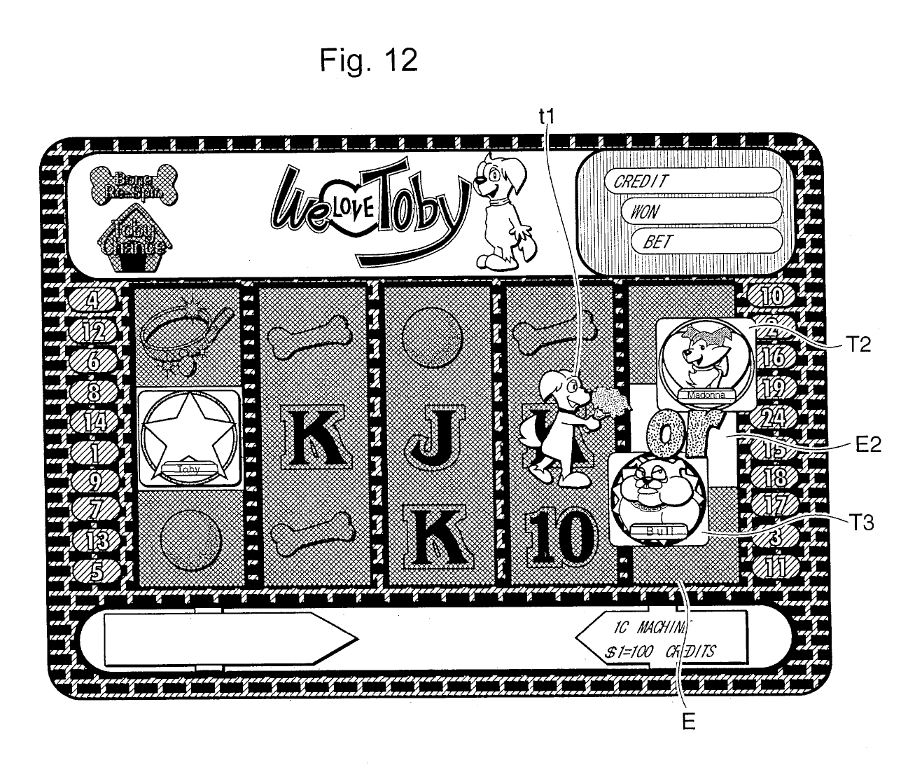

Subsequently, as shown in FIG. 12, varying of the reel image E stops, and the Madonna symbol T2 (bonus symbol) or the Bull symbol T3 (bonus symbol) is displayed on the display region E2 (S16). Thus, since the condition of switching to the bonus has been fulfilled in the step S3 as described above, the player is announced of commencement of a bonus game and the bonus game is played. Then, in the step S17, for example, after a predetermined bonus game with a higher payout rate of coins has been executed, the apparatus returns to a basic game.

In the attraction described above, the Toby character t1 sequentially moves to the display region E2 that is varying on which a bonus symbol is displayed. As the result, the player experiences a novel feeling and his or her expectations to obtain a bonus are gradually raised. On the other hand, the Toby character t1 is displayed on the display region D2 that is adjacent to the varying reel image E. The player can feel the Toby character t1 make the bonus symbol stop and his or her attention is attracted to the Toby character t1. Further, the player's sense of expectancy is maintained for a long period of time by stopping the key symbol first and the bonus symbol last.

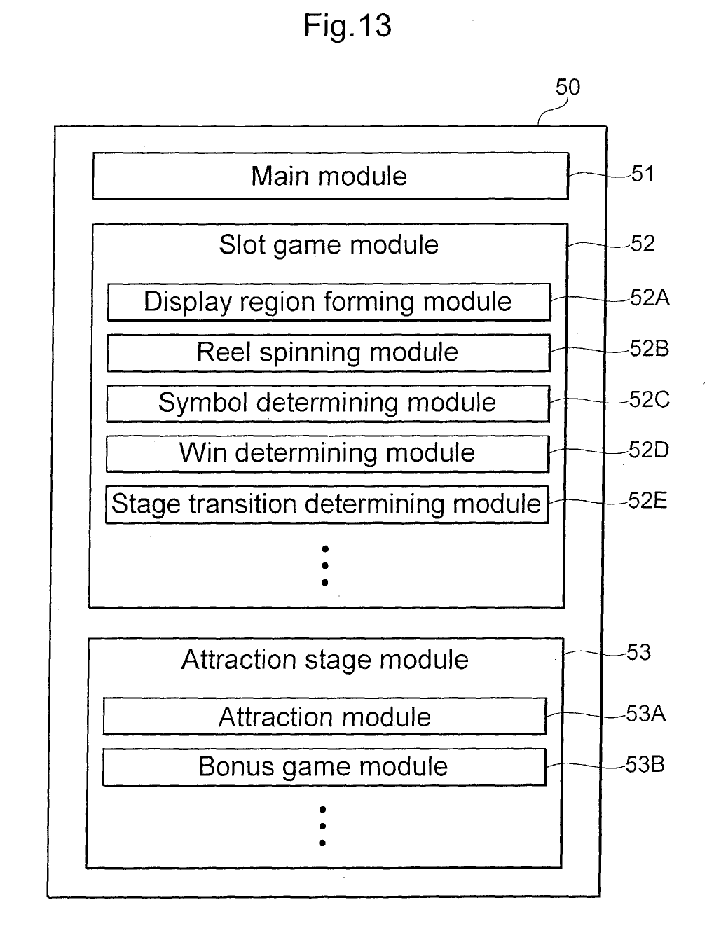

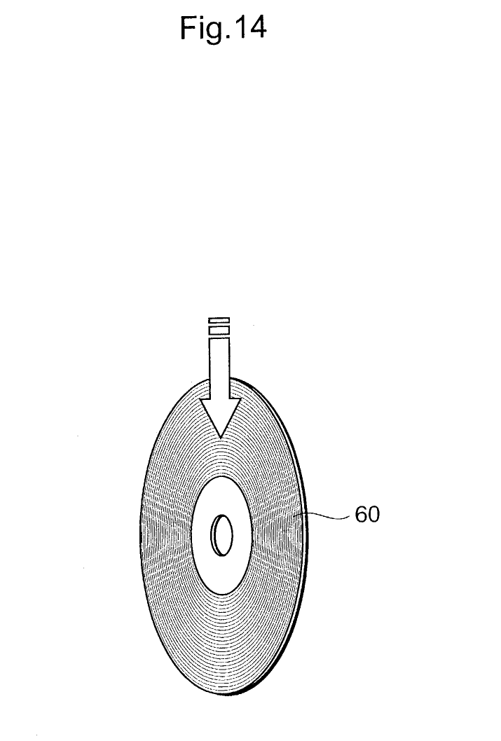

The preferable embodiments of the program according to the present invention and the computer-readable recording medium will be explained referring to FIG. 13 and FIG. 14.

FIG. 13 is a diagram showing each module in the program 50 of the present invention and FIG. 14 is a diagram showing a CD-ROM (recording medium) 60 in which the program 50 is recorded.

Program 50 includes the main module 51 which integrates the processing, the slot game module 52 which relates to basic slot game processing, and the attraction stage module 53 which relates to attraction stage processing.

Further, the slot game module 52 includes at least: the display region forming module 52A, the reel spinning module 52B, the symbol determining module 52C, the win determining module 52D and the stage transition determining module 52E.

The display region forming module 52A is one which forms a plurality of regions on the display 3 on which symbols are displayed. The reel spinning module 52B is one which displays the spinning reels A to E on the display 3. The symbol determining module 52C determines the symbols to be displayed on each display region, based on random number values. The win determining module 52D judges a prize based on the arrangement of the symbols displayed on each display region. The stage transition determining module 52E makes decisions as to transition to the attraction stage based on random number values. Through the computer's execution of each of these modules, the processing of FIG. 6 can be accomplished in above-mentioned slot machine 1.

The attraction stage module 53 at least includes the attraction module 53A and the bonus game module 53B. The attraction module 53A executes the attraction described above. The bonus game module 53B executes the prescribed bonus game. Through the computer's execution of each of these modules, the processing of FIG. 7 can be accomplished in above-mentioned slot machine 1.

By installing program 50 of the above type, received via a communications network such as the Internet, or program 50 recorded in a recording medium such as CR-ROM (recording medium) 60, in any type of computer, such as a personal computer, a PDA (Personal Digital Assistants), and so on, games similar to the above-mentioned slot machine 1 can be realized.

Note that it is acceptable to build into program 50 the image data for the symbols, characters, and so on necessary for actualizing the game; the pay table; the correspondence table of the symbol and the bonus content chosen in the bonus game and; and so on. Alternatively, these data, and so on may be installed in the computer from a source other than the program. Further, the various modules necessary for the processing performed by slot machine 1, other than modules shown in FIG. 13, may be built into program 50.

In addition, the above-mentioned recording device can be any kind of device as long as a computer can read out the written information. For example, this corresponds to magnetic disks such as floppy disks, optical disks such as DVDs, semiconductor storage devices, and so on

As described above, a preferred embodiment of the present invention was described concretely, but the present invention is not limited to the abovementioned embodiment. In the embodiment described above, the display regions, 3 rows by 5 columns, are provided in the display. It is also possible to set other types of display region arrangement. In the embodiment described above, the apparatus transfers to the attraction stage and executes the bonus game if predetermined conditions are fulfilled. It may be also made that fulfilling predetermined conditions only allows a transition to the attraction stage and it is further required to fulfill other predetermined conditions to shift to the bonus game. In the embodiment described above, the Toby symbol t1 can be displayed only in the reel image that stops first, and the Madonna symbol T2 and Bull symbol T3 can be displayed only in the reel image that stops last. It is also possible to adopt a mode wherein they are displayed in other reel images.

On the other hand, in the embodiment described above, the apparatus transfers to the bonus game if the bonus symbol is displayed. It can be also made that a predetermined amount of coins is paid to the player as a bonus without transferring to the bonus game.

As described above, with the present invention, it is possible to give a player a novel feeling and to attract his or her attention by moving said character to the varying display region when the display region is varyingly displayed.

What is claimed is:

1. A gaming apparatus comprising: a display having a plurality of symbol display regions on which a plurality of types of symbols is varyingly displayed; and a controller for executing a prescribed program and controlling a display content of said display;
wherein said controller; determines symbols to be displayed from among a plurality of types of said symbols on said display region; sequentially stops said symbols on each of said display regions that are varyingly displayed; stops the key symbol on a predetermined display region when predetermined conditions are fulfilled; and moves a predetermined character from said key symbol towards said display regions that are varyingly displayed when at least one of the other display regions is varying.

2. The gaming apparatus according to claim 1, wherein a plurality of said display regions forms a line; said apparatus is constructed in such a way that the varying display of said symbols stops in sequential order on said display regions that form a line; said character is repeatedly made to move to said adjacent display region after the varying display of said symbols have stopped on the display region adjacent to the display region where said character exists.

3. The gaming apparatus according to claim 1, wherein the apparatus transfers to a mode to give a player a bonus when predetermined conditions have been fulfilled; a bonus symbol is made to stop on a display region that stops the varying of display last among a plurality of said display regions in said mode; and said character is made to move to a display region where said bonus symbol is displayed.

4. The gaming apparatus according to claim 2, wherein the apparatus transfers to a mode to give a player a bonus when predetermined conditions have been fulfilled; a bonus symbol is made to stop on a display region that stops varying of display last from among a plurality of said display regions in said mode; and said character is made to move towards a display region where said bonus symbol is displayed.

5. The gaming apparatus according to claim 1, wherein a plurality of reel images, as a plurality of said display regions, is displayed on a display; and said key symbol can be displayed only in the reel image that the varying display stops first from among a plurality of said reel images.

6. The gaming apparatus according to claim 2, wherein a plurality of reel images, as a plurality of said display regions, is displayed on a display; and said key symbol can be displayed only in the reel image that the varying display stops first from among a plurality of said reel images.

7. The gaming apparatus according to claim 3, wherein a plurality of reel images, as a plurality of said display regions, is displayed on a display; and said key symbol can be displayed only in the reel image that the varying display stops first from among a plurality of said reel images.

8. The gaming apparatus according to claim 4, wherein a plurality of reel images, as a plurality of said display regions, is displayed on a display; and said key symbol can be displayed only in the reel image that the varying display stops first from among a plurality of said reel images.

9. A control method for a gaming apparatus comprising a display having a plurality of display regions on which a plurality of types of symbols is varyingly displayed, and a controller for executing a predetermined program and controlling a display content of said display; said control method comprising the steps of: determining symbols, from among a plurality of said symbols, to be displayed on each of said display regions; stopping sequentially said symbol on each of said display regions that is varyingly displayed; stopping a key symbol on a predetermined display region when predetermined conditions are fulfilled; and moving a predetermined character from said key symbol towards the varying display region when at least one of the other display regions is varyingly displayed.

10. The gaming apparatus control method according to claim 9, wherein the apparatus is configured such that a plurality of said display regions forms a line and the varying display of said symbols stops sequentially on said display regions formed in a line; and the method repeats a step where said character moves to said adjacent display region after the varying of said display region has stopped on the display region adjacent to the display region in which said character exists.

11. A program making a computer execute the steps of: displaying on a display of a gaming apparatus a plurality of display regions on which a plurality of types of symbols is varyingly displayed; determining symbols to be displayed on each of said display regions from among a plurality of types of said symbols; stopping said symbols subsequently on each of said display regions that are varyingly displayed; stopping a key symbol on a predetermined display region when predetermined conditions are fulfilled; and moving a predetermined character from said key symbol towards said varying display region when at least one of other display regions is varying.

12. A program according to claim 11, wherein the program is constructed such that a plurality of said display regions forms a line and the varying display of said symbols sequentially stops on said display regions formed in a line; and makes a computer execute the steps of: repeatedly moving said character to said adjacent display region after the varying display of said symbols has stopped on the display region adjacent to the display region where said character exists.

13. A computer-readable recording medium characterized in that the program of claim 11 is recorded therein.

14. A computer-readable recording medium characterized in that the program of claim 12 is recorded therein.
